(19) United States
(12) Patent Application Publication
(10) Pub. No.: US 2008/0094653 A1
(43) Pub. Date: Apr. 24, 2008

(54) IMAGE READING APPARATUS, IMAGE READING METHOD AND IMAGE FORMING APPARATUS

(75) Inventor: Shinji Miwa, Numazu-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 11/876,148

(22) Filed: Oct. 22, 2007

Related U.S. Application Data
(60) Provisional application No. 60/862,565, filed on Oct. 23, 2006.

(30) Foreign Application Priority Data
Oct. 2, 2007 (JP) 2007-258876

(51) Int. Cl. H04N 1/04; G06F 15/00

(52) U.S. Cl. 358/1.14

(57) ABSTRACT

In the case where an exposure lamp goes off while original documents are read continuously, the abnormality is detected, an original reading operation is stopped, and an error display is performed, so that a black copy output is prevented.

### CROSS-REFERENCE TO RELATED APPLICATIONS

This application is based upon and claims the benefit of priority from the prior U.S. Provisional Patent Application No. 60/862,565, filed on Oct. 23, 2006 and Japanese Patent Application No. 2007-258876, filed on Oct. 2, 2007, the entire contents of which are incorporated herein by reference.

### BACKGROUND OF THE INVENTION

1. Field of the Invention

The present invention relates to an image reading apparatus including an automatic document feeder to feed plural original documents one by one to a specified reading position, an image reading method and an image forming apparatus.

2. Description of the Related Art

An image reading apparatus used for a copier or the like includes an automatic document feeder (ADF) to transport original documents one by one to an original reading position. In the image reading apparatus including the ADF, reading of an original document using a sheet-through system is realized in which plural original documents are continuously transported by the ADF to the original reading position, and each line of the transported original documents is read at the specified original reading position. In the image reading apparatus to perform the sheet-through system as stated above, a rectangular through-read glass is provided at the original reading position, light from an exposure lamp illuminates the original document surface through the through-read glass, the reflected light is condensed by a lens, and the condensed light is read by a CCD line sensor.

In the image reading apparatus capable of reading original documents by the sheet-through system, a white reference plate (shading plate) as a reference for correcting a read image is provided at the side of the through-read glass at the original reading position. In the image reading apparatus as stated above, at the time of start of the original reading, the shading plate is read and the read image of the original document is corrected.

There is also an image reading apparatus in which in the case where original documents continuously transported by an ADF are read, in order to prevent the density of an image from changing due to the change of the light quantity of an exposure lamp to illuminate the original reading position, a reading operation of a shading plate is performed at specified intervals (JP-A-2002-232657).

### BRIEF SUMMARY OF THE INVENTION

It is an object of the present invention to provide an image reading apparatus in which abnormality of a lamp is detected at the time of continuous original reading.

In an aspect of the present invention, an image reading apparatus includes

transport means for taking in an original document one by one and for successively transporting the original document to an original reading position,

support means for supporting the original document transported by the transport means at the original reading position,

lighting means for lighting the original reading position,

reading means for reading the original document at the original reading position, and

detection means for detecting presence or absence of abnormality of the lighting means based on output data read by the reading means before the original document transported by the transport means reaches the original reading position, wherein in a case where the detection means detects the abnormality of the lighting means, subsequent original reading is stopped.

### DESCRIPTION OF THE DRAWINGS

FIG. 1 is an outer appearance view showing an outer appearance structure of a digital copier including an image reading apparatus of the invention.

FIG. 2 is a sectional view showing a structural example of the image reading apparatus in which an ADF is provided.

FIG. 3 is a block diagram showing a structure of a control system in the image forming apparatus.

FIG. 4 is a flowchart for explaining an operation of a lamp abnormality detection process.

### DETAILED DESCRIPTION OF THE INVENTION

Throughout this description, the embodiments and examples shown should be considered as exemplars, rather than limitations on the apparatus and methods of the present invention.

Hereinafter, an embodiment of the invention will be described with reference to the drawings.

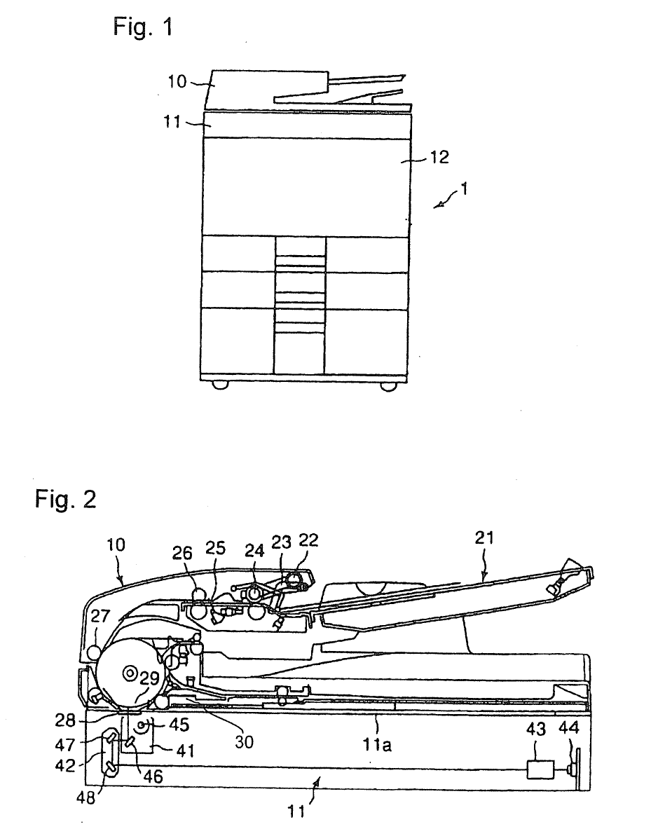

FIG. 1 is an outer appearance view showing an outer appearance structure of an image forming apparatus 1 using an electrophotographic system, which relates to an image reading apparatus of the invention. The image forming apparatus 1 is, for example, a digital copier.

As shown in FIG. 1, the image forming apparatus 1 includes a scanner unit 11 having an automatic document feeder (ADF) 10 and a printer engine unit (image forming means) 12 to form an image corresponding to image data supplied from the scanner unit 11 or the outside.

The automatic document feeder (ADF) 10 is for feeding an original document one by one to a specified reading position. The scanner unit 11 optically reads an image of the original document and converts it into image data. The ADF 10 and the scanner unit 11 form an image reading apparatus.

In the printer engine unit 12, an electrostatic latent image is formed on an image bearing body such as a photoconductive drum, the electrostatic latent image is developed with a toner, the developed toner image is transferred to a sheet as an image-formed medium, and the transferred toner image is fixed to the sheet. By the structure as stated above, in the image forming apparatus 1, the image read by the scanner unit 11 can be copied to the sheet as the image-formed medium by the printer engine unit 12.

FIG. 2 is a sectional view showing an inner structure of the ADF 10 and the scanner unit 11 used in the image forming apparatus 1.

As shown in FIG. 2, the ADF 10 used in the image forming apparatus 1 includes an original tray 21 on which plural original documents can be placed. A sheet of the original document on the original tray 21 is picked up one by one by a pickup roller 22. The sheet of the original document picked up by the pickup roller 22 is detected by an original detection switch 23 to detect an original document, and then is fed by a paper feed roller 24. The sheet of the original document fed by the paper feed roller 24 is detected by a registration switch 25, and reaches a position near a registration roller 26.

The registration switch 25 is a sensor to detect the arrival to the position near the registration roller 26. The registration roller 26 is a roller to transport the sheet of the original document to a specified original reading position.

It is detected by the registration switch 25 that the sheet of the original document fed by the paper feed roller 24 reaches the position near the registration roller 26, and is transported to the specified original reading position by the registration roller 26 at a specified timing. Besides, a supplementary roller 27 to assist the transport of the original document from the registration roller 26 to the original reading position is provided between the registration roller 26 and the original reading position.

The image of the original document transported to the original reading position by the registration roller 26 is read by the scanner unit 11 adjacent to the ADF 10. At the original reading position, a through-read glass 28 is provided in the scanner unit 11. A white original guide plate 29 is provided at the ADF 10 side of the through-read glass 28. By this, at the original reading position, the sheet of the original document is transported on the through-read glass 28 along the white original guide plate 29.

A shading plate 30 as a reference for correcting a read image is provided at the side of the through-read glass 28.

Besides, at the original reading position, as described later, light for reading the image of the original surface is irradiated from the scanner unit 11 through the through-read glass 28. Incidentally, in the case where the original document is a thin paper, since the color of the white original guide plate 29 is seen through the paper at the original reading position, there is a possibility that the color of the original sheet can not be reproduced faithfully. Thus, the white original guide plate 29 is constructed of a white guide plate.

Besides, a first carriage 41, a second carriage 42, an imaging lens 43 and a CCD sensor 44 are disposed in the scanner unit 11. At a part of the upper surface of the scanner unit 11, there is provided an original glass stand 11a on which an original document is directly placed in a case where the original document is read without using the ADF 10.

The first carriage 41 is attached with an exposure lamp 45 as a light source for lighting the original document passing the through-read glass 28. As the exposure lamp 45, for example, a xenon lamp or an LED is preferable.

Besides, various mirrors 46, 47 and 48 to deflect the reflected light from the original surface to a specified direction are attached to the first and the second carriages 41 and 42.

Next, a structure of a control system in the image forming apparatus 1 will be described.

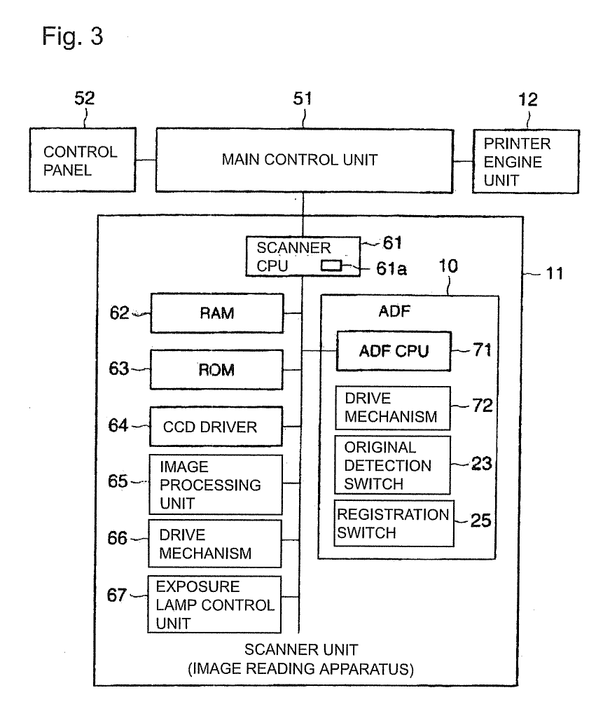

FIG. 3 is a block diagram showing the structure of the control system in the image forming apparatus 1. As shown in FIG. 3, the image forming apparatus 1 includes a main control unit 51, a control panel 52, the scanner unit 11, the printer engine unit 12 and the like.

The main control unit 51 controls the whole image forming apparatus 1. The main control unit 51 includes, for example, a ROM in which control programs and control data are stored, a RAM in which various parameters and working data are stored, an image processing unit to perform an image process, a page memory, a hard disk drive, an external interface to perform data communication with an external equipment, and the like.

As shown in FIG. 3, the control system of the scanner unit 11 includes a scanner CPU 61, a RAM 62, a ROM 63, a CCD driver 64, an image processing unit 65, a drive mechanism 66, an exposure lamp control unit 67, and the ADF 10.

The scanner CPU 61 controls the whole scanner unit 11. Besides, the scanner CPU 61 includes the timer 61a to measure time. The RAM 62 is formed of a volatile memory or the like and temporarily stores scan conditions and data such as control data. The ROM 63 is formed of a nonvolatile memory and stores control programs executed by the CPU 61 and control data. The CCD driver 64 is for driving the CCD sensor 44, and captures data from the CCD sensor 44. The image processing unit 65 is for performing an image process on image data based on the control of the scanner CPU 61. The drive mechanism 66 is a mechanism to drive a not-shown drive motor in the main body of the scanner unit 11. The exposure lamp control unit 67 is for performing lighting control of the exposure lamp 45.

The ADF 10 includes an ADF CPU 71 connected to the scanner CPU 61 and to control the whole operation of the ADF 10, and a drive mechanism 72 to drive a transport mechanism including the pickup roller 22, the paper feed roller 24, the registration roller 26, the supplementary roller 27 and the like.

Next, a reading operation of an original document by the scanner unit 11 using the ADF 10 will be described. First, when a scan start or copy start is instructed by the control panel 52, the main control unit 51 determines whether an original document is placed on the original tray 21. The original document on the original tray 21 is detected by, for example, a not-shown sensor, and information indicating the presence or absence of the original document on the original tray 21 is notified from the scanner CPU 61 to the main control unit 51.

When it is determined that the original document exists on the original tray 21, the main control unit 51 instructs the scanner CPU 61 to start the scan operation using the ADF 10.

When the start of the scan operation using the ADF 10 is instructed from the main control unit 51, the scanner CPU 61 instructs the ADF CPU 71 to transport the original document on the original tray 21. Then, the ADF CPU 71 causes the drive mechanism 72 to drive the pickup roller 22, and the uppermost original document is separated from plural original documents placed on the original tray 21. The original document separated by the pickup roller 22 is taken in the ADF 10 by the paper feed roller 24 and is transported.

Whether the original document taken in by the paper feed roller 24 has reached the registration roller 26 is determined based on the state of on or off of the registration switch 25 positioned just before it. The ADF CPU 71 monitors the detection state of the registration switch 25, and notifies the scanner CPU 61 of the detection result. The scanner CPU 61 sets, in the ADF CPU 71, a paper feed timing when the original document is fed after the registration switch 25 is turned on.

The ADF CPU 71 causes the drive mechanism 72 to rotate the registration roller 26 based on the timing specified by the scanner CPU 61, and starts the transport of the original document.

When the start of the scan operation using the ADF 51 is instructed from the main control unit 51, the scanner CPU 61 turns on a lamp lighting control signal to control the lighting state of the exposure lamp 45 and causes the exposure lamp control unit 67 to turn on the exposure lamp 45. The scanner CPU 61 causes the first and the second carriages 41 and 42 to move to the specified original reading position where an image of an original document is read through the through-read glass 28. By this, the main body of the scanner unit 11 is put in the state where the image of the original document fed by the ADF 10 can be read.

Next, an operation at the time of reading of an original document transported in the ADF 10 will be described.

Just before starting the original document feed, the reflected light quantity of the shading plate 30 is read by the CCD sensor 44. Next, the reflected light quantity of the white original guide plate 29 of the ADF 10 is read before the leading edge of the original document comes under the through-read glass 28, and is compared with the reflected light quantity of the shading plate 30. The more the original document is transported, the more the white original guide plate 29 of the ADF 10 becomes dirty, and the whiteness is changed, the detection value of the CCD sensor 44 is changed, and the abnormality detection of the exposure lamp described later may not be performed accurately. Therefore, the detection value is corrected each time the reading of the original document is started. Further, the reflected light quantity of the white original guide plate 29 of the ADF 10 is read at intervals between the original documents under reading and after the rear edge of the final original document passes, so that the correction can be performed more periodically.

Now, when the transport of the original document is started by the ADF 10, the ADF CPU 71 starts an original size detection process to detect the size of the fed original document. Although described later in detail, this original size detection process detects the size of the original document based on the timing when the transport of the original document is started and the timing when the rear edge of the original document passes. That is, in the original size detection process, the size of the original document in the transport direction is determined based on a time period from the start of the transport to the turn-off of the registration switch 25.

When a time (original reading start time) obtained by the transport speed of the original document and the transport distance has passed, the leading edge of the original document whose transport was started by the registration roller 26 reaches the original reading position where the white original guide plate 22 is provided. In the case where the transport speed of the original document in the ADF 10 is constant, the time period in which the leading edge of the original document is transported from the registration roller 26 to the original reading position is constant irrespective of the size of the original document. Thus, it is assumed that the original reading start time is constant.

That is, the scanner CPU 61 uses the timer 61a to measure the time from the start of the transport of the original document by the registration roller 26, and determines whether the specified original reading start time has passed. By this determination, when it is determined that the specified original reading start time has passed, the scanner CPU 61 starts the reading operation of the original document at the original reading position.

Further, the scanner CPU 61 uses the timer 61a to measure the time from the start of reading of the original document (or the start of transport of the original document by the registration roller 26), and it is determined whether the time (original reading end time) has passed so that the rear edge of the original document passes the original reading position. By this determination, when it is determined that the original reading end time has passed, the scanner CPU 61 ends the reading of the image of the original document surface.

The original reading end time is calculated based on, for example, the size of the original document in the transport direction calculated by the original size detection process and the transport speed of the original document in the ADF 10. Besides, the original reading end time may be calculated as the time period between the time point when the rear edge of the original document passes the registration roller 26 and the time point when the rear edge passes the original reading position. In this case, when the transport speed of the original document in the ADF 10 is constant, similarly to the original reading start time, the original reading end time between the time point when the rear edge of the original document passes the registration roller 26 and the time point when the rear edge passes the original reading position is constant irrespective of the size of the original document.

When the reading of the image of the original document at the original reading position is ended, the scanner CPU 61 performs a lamp abnormality detection process to detect the lighting state of the exposure lamp 45 described later. Besides, the respective original documents whose reading is completed by the foregoing operation are successively discharged onto a paper discharge tray.

Next, the original size detection process will be described.

When the original size detection process is started, the scanner CPU 61 uses the timer 61a to start a time measuring process for size detection. That is, when the transport of the original document is started by the registration roller 26, the scanner CPU 61 uses the timer 61a to start the timer for size detection.

When the timer 61a is started, the scanner CPU 61 performs the time measuring process for size detection by the timer 61a until the registration switch 25 is turned off. That is, when receiving the notification through the ADF CPU 71 that the registration switch 25 is turned off, the scanner CPU 61 stops the timer for size detection through the timer 61a.

When the timer for size detection is stopped, the scanner CPU 61 calculates the size of the original document in the transport direction based on the time measured by the timer for size detection and the transport speed of the original document in the ADF 10. The transport speed of the original document in the ADF 10 is previously stored in, for example, the ROM 63. By this, in the original size detection process, at least when the rear edge of the original document passes the registration roller 26 (that is, the registration switch 25), the size of the original document in the transport direction is detected. Accordingly, even in the case where original documents of different sizes are mixedly placed, the rear edge of the fed original document can be known. At the timing when there is no original document, since the white original guide plate 29 located in the original transport path of the ADF 10 is white, in case the exposure lamp 45 goes off, the lamp go-off can be determined by the output signal of the CCD sensor 44.

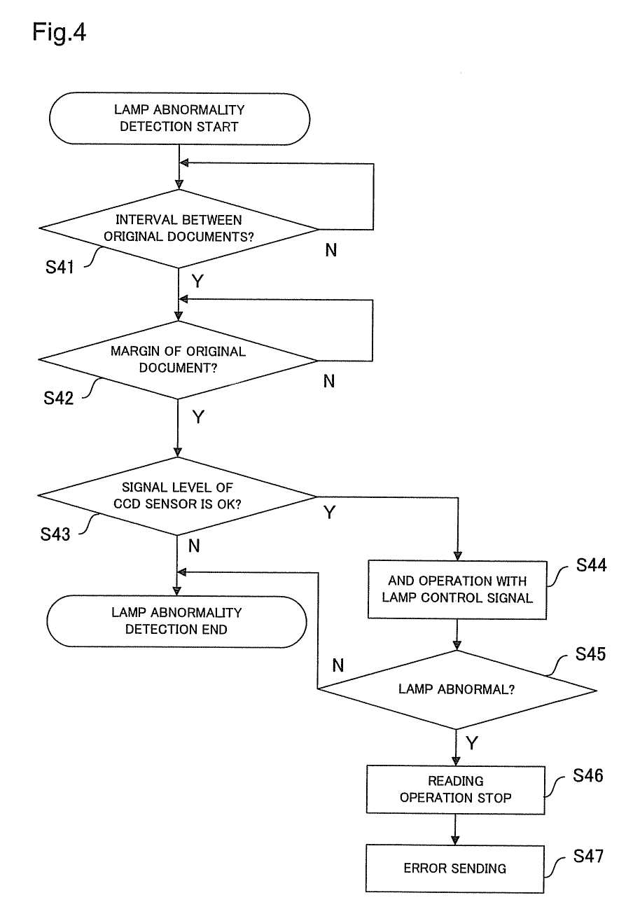

Next, the lamp abnormality detection process to detect the abnormality of the exposure lamp 45 will be described with reference to FIG. 4.

The lamp abnormality detection process is for detecting the lighting state of the exposure lamp 45 at intervals between the respective original documents successively transported by the ADF 10.

When reading of the original document is not performed, the exposure lamp goes off, and when the original reading is continuously started, the exposure lamp continues to be lit during the reading.

First, as described above, just before starting the original document feed, the reflect light quantity of the shading plate 30 is read by the CCD sensor 44. Next, the reflected light quantity of the white original guide plate 29 of the ADF 10 is read before the leading edge of the original document comes under the through-read glass 28, and is compared with the reflected light quantity of the shading plate 30.

In this way, by grasping the reference voltage of the CCD sensor in the state before the exposure lamp is turned on, the CCD sensor output in the case where the exposure lamp burns out and goes off can be grasped. Besides, by grasping the reference voltage of the CCD sensor in the state before the original document is fed, it becomes possible to grasp the CCD sensor output at intervals between the original documents under continuous reading or the CCD sensor output at margins of the original documents.

In FIG. 4, first, it is determined whether reading is performed at an interval between original documents (step S41). Next, it is determined whether reading is performed at a margin of the original document (step S42). When YES, the quality of the signal level read by the CCD sensor is determined (step S43). When it is determined that the exposure lamp goes off, an AND operation with the lamp control signal (ON signal) is performed, and the exposure lamp abnormality is determined (step S44).

When the lamp abnormality is confirmed (step S45), the scanner unit turns OFF the lamp control signal and stops the reading operation (step S46). Next, an error (serviceman call) is sent to the image forming apparatus (step S47). The image forming apparatus displays the serviceman call on the control panel, and stops the print operation of the image forming apparatus to notify the user of the lamp abnormality.

According to the invention, by the determination control of the exposure lamp abnormality, in the case where the exposure lamp goes off due to some trouble while original documents are read continuously, the abnormality is detected to stop the operation and the error is displayed, so that a black copy output can be prevented.

Although exemplary embodiments of the present invention have been shown and described, it will be apparent to those having ordinary skill in the art that a number of changes, modifications, or alterations to the invention as described herein may be made, none of which depart from the spirit of the present invention. All such changes, modifications, and alterations should therefore be seen as within the scope of the present invention.

What is claimed is:

1. An image reading apparatus comprising:
transport means for taking in an original document one by one and for successively transporting the original document to an original reading position;
support means for supporting the original document transported by the transport means at the original reading position;
lighting means for lighting the original reading position;
reading means for reading the original document at the original document reading position; and
detection means for detecting presence or absence of abnormality of the lighting means based on output data read by the reading means before the original document transported by the transport means reaches the original reading position,
wherein in a case where the detection means detects the abnormality of the lighting means, subsequent original reading is stopped.

2. The image reading apparatus according to claim 1, wherein the detection means uses, as references, output data of the reading means before original document feed and output data of the reading means at a time when the lighting means goes off.

3. The image reading apparatus according to claim 2, wherein the detection means confirms the abnormality of the lighting means by determination of the abnormality of the lighting means based on the reference output data and an AND operation with a lighting control signal of the lighting means.

4. The image reading apparatus according to claim 1, wherein the lighting means is an exposure lamp, the transport means is a registration roller, the support means is a through-read glass, and the reading means is a CCD sensor.

5. An image forming apparatus comprising:
transport means for taking in an original document one by one and for successively transporting the original document to an original reading position;
support means for supporting the original document transported by the transport means at the original reading position;
lighting means for lighting the original reading position;
reading means for reading the original document at the original reading position;
image forming means for forming an image of the original document onto an image-formed medium based on image data of the original document read by the reading means; and
detection means for detecting presence or absence of abnormality of the lighting means based on output data read by the reading means before the original document transported by the transport means reaches the original reading position;
wherein in a case where the detection means detects the abnormality of the lighting means, subsequent original reading is stopped.

6. The image forming apparatus according to claim 5, wherein
after the original document reading is stopped, an error of the lighting means is sent to the image forming means, and image formation is stopped.

7. The image forming apparatus according to claim 6, wherein
after the image formation is stopped, a serviceman call is displayed on a control panel.

8. An image reading method used for an image forming apparatus including transport means for taking in an original document one by one and for transporting the original document to an original reading position, support means for supporting the original document transported by the transport means at the original reading position, lighting means for lighting the original reading position, and reading means for reading the original document at the original document reading position lid by the lighting means, comprising:
a transport step of taking in the original document one by one by the transport means and successively transporting the original document to the original reading position;
a process step of reading an image of the original document located at the original reading position by the reading means;
a detection step of detecting presence or absence of abnormality of the lighting means based on output data read by the reading means before the original document transported by the transport means reaches the original reading position; and
a reading stop step of stopping subsequent original reading in a case where the detection means detects the abnormality of the lighting means.

9. The image reading method according to claim 8, wherein the detection step uses, as references, output data of the reading means before original document feed and output data of the reading means at a time when the lighting means goes off.

10. The image reading method according to claim 9, wherein at the detection step, the abnormality of the lighting means is confirmed by determination of the abnormality of the lighting means based on the reference output data and an AND operation with a lighting control signal of the lighting means.
